(19) United States
(12) Patent Application Publication
(10) Pub. No.: US 2011/0041510 A1
(43) Pub. Date: Feb. 24, 2011

(54) FUEL CONTROL APPARATUS FOR GAS TURBINE ENGINE

(75) Inventors: Toru Sasaki, Wako-shi (JP); Norio Kasai, Wako-shi (JP)

Correspondence Address: RANKIN, HILL & CLARK LLP, 38210 GLENN AVENUE, WILLOUGHBY, OH, 44094-7808, US

(73) Assignee: HONDA MOTOR CO., LTD., Tokyo (JP)

(21) Appl. No.: 12/861,286

(22) Filed: Aug. 23, 2010

(30) Foreign Application Priority Data
Aug. 24, 2009 (JP) 2009-192934

(51) Int. Cl. F02C 7/22; F02C 9/28

(52) U.S. Cl. 60/776; 60/39.281

(57) ABSTRACT

In an apparatus for controlling a flow rate of fuel to be supplied to a combustion chamber of a gas turbine engine having a turbine rotated by combustion gas injected from the combustion chamber and a compressor for compressing air to be supplied to the combustion chamber, a first fuel flow rate at starting of the engine is calculated based on at least the detected output pressure of the compressor. In addition, a second fuel flow rate at starting of the engine is calculated based on at least the detected temperature of the inflowing air, the exhaust gas temperature and the rotational speed of the compressor, one of the first and second fuel flow rates is selected based on the detected exhaust gas temperature and operation of a fuel metering valve is controlled based on the selected fuel flow rate, thereby enabling to prevent white smoke at engine starting even when the engine is in the unstable range where the exhaust gas temperature is low.

### BACKGROUND OF THE INVENTION

1. Field of the Invention

This invention relates to a fuel control apparatus for an aeroplane gas turbine engine, particularly to a fuel control apparatus that determines the optimal fuel flow rate at engine starting and controls to achieve the determined flow rate.

2. Description of the Related Art

In a gas turbine engine, a fuel nozzle of the engine is supplied with air compressed by a turbine compressor (compressor driven by a turbine) and sprays fuel (supplied through a fuel supply line using the compressed air) into a combustion chamber. The fuel nozzle that uses air compressed by the turbine compressor is called an air blast nozzle.

On the other hand, a fuel nozzle that additionally uses air compressed by another compressor other than the turbine compressor is called an air assist nozzle, which is taught, for example, by Japanese Laid-Open Patent Application Nos. Sho 54 (1979)-47018 and Hei 3 (1991)-105104. The air assist nozzle is superior in terms of its fuel spray performance that is not impaired even when the turbine rotational speed is low, e.g., at engine starting.

### SUMMARY OF THE INVENTION

However, the air assist nozzle requires another compressor and it results in the increase in size of the apparatus and cost. To cope with it, focusing on the use of the air blast nozzle, when the turbine rotational speed is low, e.g., at engine starting, the spray performance of the air blast nozzle degrades and consequently, if the flow rate of fuel to be supplied is not regulated appropriately, white smoke is generated.

The spray performance of the air blast nozzle depends on output pressure of the compressor, so that the fuel flow rate at engine starting is calculated based on the output pressure of the compressor. However, the flow rate calculated based thereon has been determined without taking other condition parameters into account and hence, the calculation result is not necessarily the optimal fuel flow rate in the engine unstable range where the exhaust gas temperature is low. It may disadvantageously cause the generation of white smoke.

An object of this invention is therefore to overcome the foregoing problem by providing a fuel control apparatus for a gas turbine engine which can prevent white smoke at engine starting even when the engine is in the unstable range where the exhaust gas temperature is low.

In order to achieve the object, this invention provides in its first aspect an apparatus for controlling a flow rate of fuel to be supplied to a combustion chamber of a gas turbine engine, a turbine rotated by combustion gas injected from the combustion chamber, and a compressor for compressing air to be supplied to the combustion chamber, comprising: a first pressure sensor that detects output pressure of the compressor; a first temperature sensor that detects temperature of inflowing air at an air intake of the engine; a second temperature sensor that detects temperature of exhaust gas passed through the turbine; a rotational speed sensor that detects rotational speed of the compressor; a first engine-start fuel flow rate calculator that calculates a first fuel flow rate at starting of the engine based on at least the detected output pressure of the compressor; a second engine-start fuel flow rate calculator that calculates a second fuel flow rate at starting of the engine based on at least the detected temperature of the inflowing air, the exhaust gas temperature and the rotational speed of the compressor; a fuel metering valve that is installed in a fuel supply line of the engine to regulate the flow rate of the fuel to be supplied to the combustion chamber; and a fuel metering valve controller that selects one of the first fuel flow rate and the second fuel flow rate based on the detected exhaust gas temperature and controls operation of the fuel metering valve based on the selected fuel flow rate.

In order to achieve the object, this invention provides in its second aspect a method of controlling a flow rate of fuel to be supplied to a combustion chamber of a gas turbine engine, a turbine rotated by combustion gas injected from the combustion chamber, and a compressor for compressing air to be supplied to the combustion chamber, comprising the steps of: detecting output pressure of the compressor; detecting temperature of inflowing air at an air intake of the engine; detecting temperature of exhaust gas passed through the turbine; detecting rotational speed of the compressor; calculating a first fuel flow rate at starting of the engine based on at least the detected output pressure of the compressor; calculating a second fuel flow rate at starting of the engine based on at least the detected temperature of the inflowing air, the exhaust gas temperature and the rotational speed of the compressor; and selecting one of the first fuel flow rate and the second fuel flow rate based on the detected exhaust gas temperature and controlling operation of a fuel metering valve installed in a fuel supply line of the engine to regulate the flow rate of the fuel to be supplied to the combustion chamber.

### BRIEF DESCRIPTION OF THE DRAWINGS

The above and other objects and advantages of the invention will be more apparent from the following description and drawings in which:

FIG. 1 is an overall schematic view of a gas turbine engine to which a fuel control apparatus for a gas turbine engine according to an embodiment of this invention is applied;

FIG. 2 is a block diagram for explaining the processing for calculating a fuel flow rate at engine starting by an electronic control unit (ECU) shown in FIG. 1; and

FIG. 3 is a time chart for explaining the processing for switching between fuel flow rates in an engine-start fuel flow rate switching block shown in FIG. 2.

### DETAILED DESCRIPTION OF THE PREFERRED EMBODIMENT

A fuel control apparatus for a gas turbine engine according to a preferred embodiment of the present invention will now be explained with reference to the attached drawings.

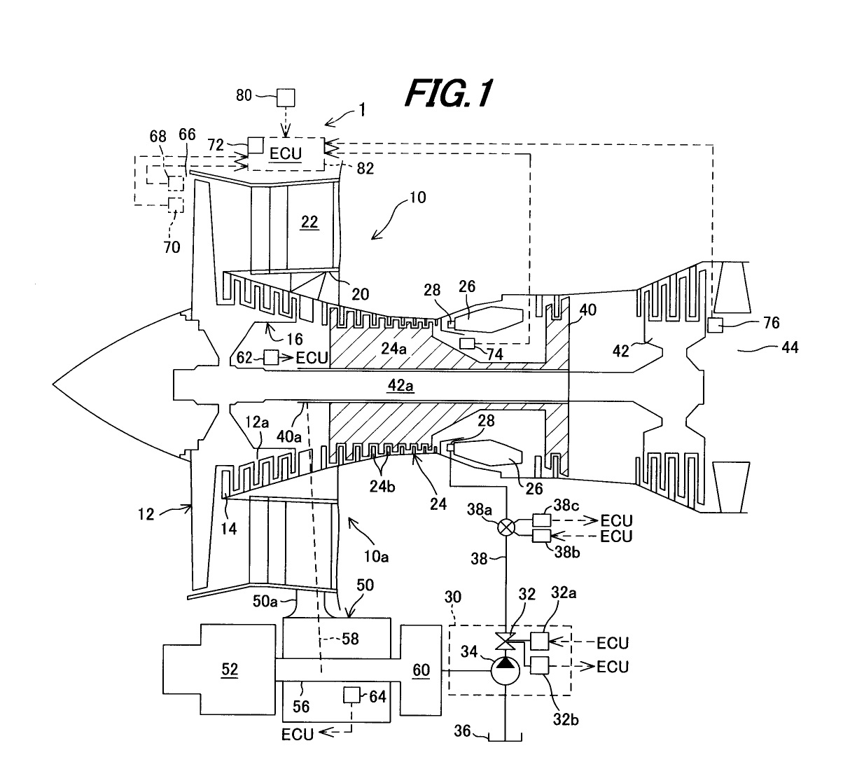

FIG. 1 is an overall schematic view of a gas turbine engine to which a fuel control apparatus for a gas turbine engine according to an embodiment of this invention is applied.

In FIG. 1, reference numeral 1 designates a fuel control apparatus for a gas turbine engine according to this embodiment. The gas turbine engine is explained first for ease of understanding.

Four types of gas turbine engines, i.e., aeroplane gas turbine engines are commonly known: the turbojet engine, turbofan engine, turboprop engine and turboshaft engine. A two-shaft turbofan engine will be taken as an example in the following explanation.

In FIG. 1, reference numeral 10 designates a turbofan engine (gas turbine engine; hereinafter referred to as “engine”). Reference numeral 10a designates a main engine unit. The engine 10 is mounted at an appropriate location of an aircraft (airframe; not shown).

The engine 10 is equipped with a fan (fan blades) 12 that sucks in air while rotating rapidly. A rotor 12a is formed integrally with the fan 12. The rotor 12a and a stator 14 facing it together form a low-pressure compressor 16 that compresses the sucked-in air and pumps it rearward.

A duct or bypass 22 is formed in the vicinity of the fan 12 by a separator or splitter 20. Most of the air pulled in passes through the duct 22 to be jetted rearward of the engine 10 without being burned at a later stage (in the core). The force of the air accelerated rearward by the fan 12 produces a force of reaction that acts on the airframe (not shown), at which the engine 10 is mounted, as a propulsive force (thrust). Most of the propulsion is produced by the air flow from the fan.

The air compressed by the low-pressure compressor 16 flows rearward to a high-pressure compressor 24 where it is further compressed by a rotor 24a and stator 24b and then flows rearward to a combustion chamber 26.

The combustion chamber 26 is equipped with a fuel nozzle 28 that is supplied with pressurized fuel metered by an FCU (fuel control unit) 30. The FCU 30 is equipped with a fuel metering valve (FMV) 32. Fuel pumped by a fuel pump (gear pump) 34 from a fuel tank 36 located at an appropriate part of the airframe is metered or regulated by the fuel metering valve 32 and supplied to the fuel nozzle 28 through a fuel supply line 38.

The fuel metering valve 32 is connected to a torque motor 32a to be opened/closed thereby. Based on a command sent from an electronic control unit (ECU; explained later), the torque motor 32a operates the fuel metering valve 32 to open and close. The ECU outputs a command in accordance with a position of a thrust lever (not shown) manipulated by the pilot (operator). An opening sensor 32b is installed near the fuel metering valve 32 to detect the opening thereof. The fuel metering valve 32 is a normally closed type.

A fuel shutoff valve (SOV) 38a is interposed in the fuel supply line 38. The fuel shutoff valve 38a is connected to an electromagnetic solenoid 38b to be opened/closed thereby. Based on a command sent from the ECU, the solenoid 38b operates the fuel shutoff valve 38a to open and close. Specifically, when a shutoff command is outputted, the fuel shutoff valve 38a is closed to shut off the fuel supply to the fuel nozzle 28. The fuel shutoff valve 38a is a normally closed type.

The fuel nozzle 28 is supplied with compressed air from the high-pressure compressor 24 and sprays fuel supplied through the fuel supply line 38 using the compressed air. The fuel nozzle 28 comprises an air blast nozzle that uses solely compressed air to make fuel into spray.

The sprayed fuel from the fuel nozzle 28 is mixed with compressed air and the air-fuel mixture is burned after being ignited at engine starting by an ignition unit (not shown) having an exciter and a spark plug. Once the air-fuel mixture begins to burn, the air-fuel mixture composed of compressed air and fuel is continuously supplied and burned.

The hot high-pressure gas produced by the combustion is sent to a high-pressure turbine 40 to rotate it at high speed. The high-pressure turbine 40 is connected to the rotor 24a of the high-pressure compressor 24 through a high-pressure turbine shaft 40a to rotate the rotor 24a to drive the compressor 24.

After driving the high-pressure turbine 40, the hot high-pressure gas is sent to a low-pressure turbine 42 (after passing through the high-pressure turbine 40, the gas becomes lower in pressure than gas sprayed from the combustion chamber 26) to rotate it at relatively low speed. The low-pressure turbine 42 is connected to the rotor 12a of the low-pressure compressor 16 through a low-pressure turbine shaft 42a. The rotor 12a and fan 12 are therefore also rotated. The high-pressure turbine shaft 40a and the low-pressure turbine shaft 42a are provided in a dual concentric structure.

The turbine exhaust gas passing through the low-pressure turbine 42 is mixed with the fan exhaust air passing through the duct 22 without compression or combustion and the combined flow is jetted rearward of the engine 10 through a jet nozzle 44.

An accessory drive gearbox (hereinafter referred to as “gearbox”) 50 is attached to the undersurface at the front end of the main engine unit 10a through a stay 50a. An integrated starter/generator (hereinafter called “starter”) 52 is attached to the front of the gearbox 50. The FCU 30 is located at the rear of the gearbox 50.

When the engine 10 is started, a starter 52 is operated to rotate a shaft 56 and the rotation thereof is transmitted through a drive shaft 58 (and a gear mechanism including a bevel gear etc. (not shown)) to the high-pressure turbine shaft 40a to generate compressed air. The compressed air is supplied to the fuel nozzle 28, as mentioned above.

The rotation of the shaft 56 is also transmitted to a PMA (Permanent Magnet Alternator) 60 and the (high-pressure) fuel pump 34. The fuel pump 34 is therefore driven to pump and spray metered fuel from the fuel nozzle 28 as explained above. The resulting air-fuel mixture is ignited to start combustion.

When the engine 10 reaches self-sustaining operating speed, the rotation of the high-pressure turbine shaft 40a is transmitted back to the shaft 56 through the drive shaft 58 (and the gear mechanism including the bevel gear etc. (not shown)) to drive the fuel pump 34 and also drive the PMA 60 and starter 52. The PMA 60 therefore generates electricity and the starter 52 also generates electricity to be supplied to the airframe. When electric load on the airframe side is increased, power generated by the starter 52 is increased and rotational load of the high-pressure turbine shaft 40a is increased accordingly, thereby affecting the high-pressure compressor rotational speed, which will be explained later.

An N1 sensor (speed sensor) 62 is installed near the low-pressure turbine shaft 42a of the engine 10 and generates an output or signal proportional to the rotational speed of the low-pressure compressor (rotational speed of the low-pressure turbine shaft 42a) N1. An N2 sensor (speed sensor) 64 is installed near the shaft 56 and generates an output or signal proportional to the rotational speed of the high-pressure compressor (rotational speed of the high-pressure turbine shaft 40a) N2.

A T1 sensor (temperature sensor) 68 and P1 sensor (pressure sensor) 70 are installed near an air intake 66 at the front of the main engine unit 10a and generate outputs or signals proportional to the temperature (ambient temperature of the aircraft) T1 and the pressure P1, respectively, of the inflowing air at that location. A P0 sensor (pressure sensor) 72 is installed inside the ECU explained below and generates an output or signal proportional to atmospheric pressure P0. Further, a temperature sensor (not shown) is installed inside the ECU and generates an output or signal proportional to the temperature of the ECU.

Furthermore, a P3 sensor (pressure sensor) 74 is installed downstream of the rotor 24a and generates an output or signal proportional to the output pressure P3 of the high-pressure compressor 24. An EGT sensor (temperature sensor) 76 is installed at an appropriate location downstream of the low-pressure turbine 42 and generates an output or signal proportional to the exhaust gas temperature EGT (low-pressure turbine outlet temperature). A WOW sensor (weight sensor) 80 is installed near a wheel of the airframe and produces an output or signal indicative of the weight acting on the wheel, i.e., indicating whether the aircraft is on ground.

The aforementioned ECU (now designated by reference numeral 82) comprises a microprocessor and is housed in the main engine unit 10a at its upper end. The outputs of the foregoing sensors indicating the operating condition of the engine 10 are sent to the ECU 82. The ECU 82 calculates a Mach number Mn indicating flight speed of the aircraft based on a ratio of the atmospheric pressure P0 to the pressure P1 and the flight altitude ALT based on the atmospheric pressure P0.

It should be noted that, among the foregoing sensors, some sensors are configured to be redundant for safety. Specifically, there are installed the two N1 sensors, four N2 sensors, two T1 sensors, eight EGT sensors, two P0 sensors, two P1 sensors (but no P1 sensor in the case where the signal of Mach number Mn is sent from the airframe side and based thereon, the pressure P1 is calculated), and two P3 sensors.

Further, based on the outputs of the sensors, the ECU 82 performs various types of engine control. One type of the engine control is calculating a fuel flow rate at engine starting based on the outputs of the sensors and controlling the opening of the fuel metering valve 32 to achieve the calculated flow rate of fuel to be supplied to the fuel nozzle 28 (combustion chamber 26). Thus the fuel control apparatus 1 comprises at least the ECU 82, foregoing sensors and fuel metering valve 32.

The processing for calculating the fuel flow rate at engine starting by the ECU 82 will be explained.

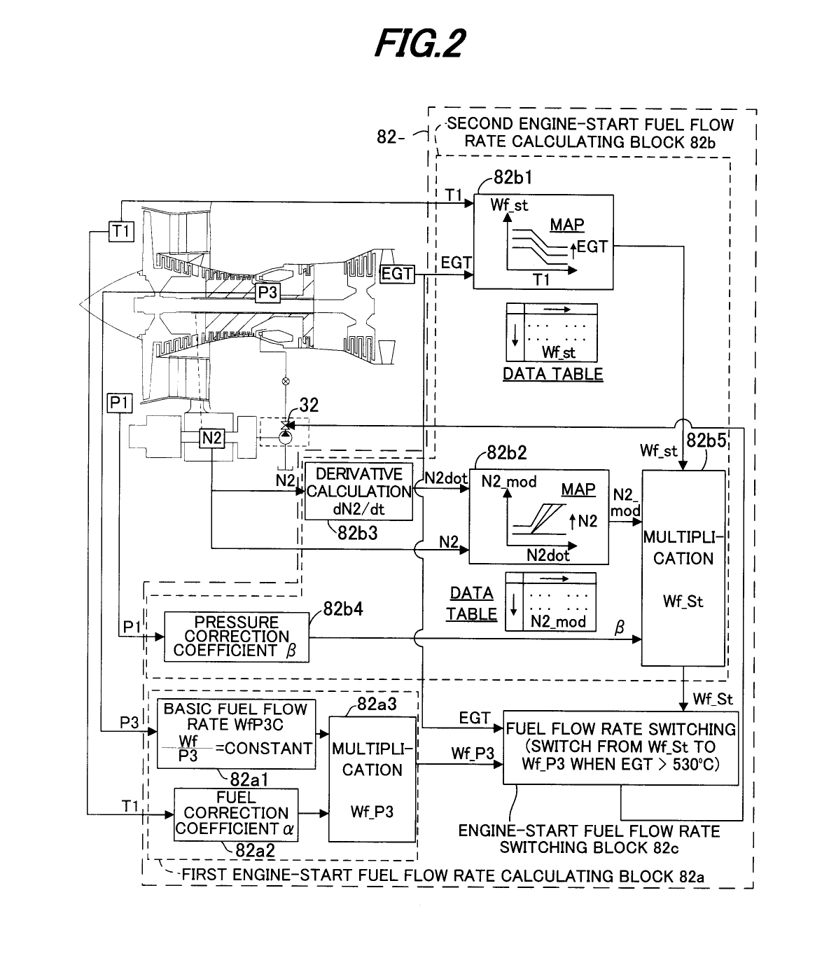

FIG. 2 is a block diagram for explaining the processing. This processing is conducted by the ECU 82 at predetermined regular intervals, e.g., 100 milliseconds.

The ECU 82 includes a first engine-start fuel flow rate calculating block (first block) 82a, second engine-start fuel flow rate calculating block (second block) 82b and engine-start fuel flow rate switching block (switching block) 82c.

A basic fuel flow rate calculating block 82a1 of the first block 82a is inputted with the output pressure P3 of the high-pressure compressor 24 and based thereon, a basic fuel flow rate WfP3C is calculated. Specifically, the basic fuel flow rate WfP3C is calculated based on the premise that a ratio of the basic fuel flow rate Wf to the output pressure P3 is to be a constant value.

A fuel correction coefficient calculating block 82a2 of the first block 82a is inputted with the temperature T1 of the inflowing air and based thereon, a fuel correction coefficient α is calculated. The fuel correction coefficient α is used to correct the temperature with respect to the fuel flow rate at the standard temperature (298.15 K (25° C.)).

The calculated basic fuel flow rate WfP3C is multiplied by the fuel correction coefficient α at a multiplication block 82a3 to obtain a first engine-start fuel flow rate Wf_P3. In other words, the first engine-start fuel flow rate Wf_P3 is corrected by the fuel correction coefficient α. The first engine-start fuel flow rate Wf_P3 is calculated in pph (pound per hour).

A temperature-based fuel flow rate calculating block 82b1 of the second block 82b is inputted with the temperature T1 of the inflowing air and the exhaust gas temperature EGT and based on these temperature parameters, a temperature-based fuel flow rate Wf_st is calculated by retrieving mapped values or a data table prepared beforehand by the temperature parameters. The temperature-based fuel flow rate Wf_st is also calculated in pph (pound per hour).

The temperature-based fuel flow rate Wf_st is calculated taking the thermal condition of the engine 10 into account and, as illustrated, is calculated such that it decreases with increasing inflowing air temperature T1 and increases with increasing exhaust gas temperature EGT. Specifically, when a difference between the temperature EGT and temperature T1 is large, since it means that the thermal condition of the engine 10 is at high temperature, the temperature-based fuel flow rate Wf_st is calculated to be a small value. In contrast, when the difference is small, since it means that the thermal condition of the engine 10 is at low temperature, the temperature-based fuel flow rate Wf_st is calculated to be a large value. A rotational-speed-based fuel flow rate calculating block 82b2 of the second block 82b is inputted with the high-pressure compressor rotational speed N2 and a first-order differential value N2dot (N2 change rate) thereof, and based on these speed parameters, a rotational-speed-based fuel flow rate N2_mod is calculated by retrieving mapped values or a data table prepared beforehand by the speed parameters. The first-order differential value N2dot of the high-pressure compressor rotational speed N2 is calculated in a derivative calculating block 82b3 positioned upstream.

The rotational-speed-based fuel flow rate N2_mod is calculated taking a compression force of the high-pressure compressor 24 driven by the high-pressure turbine 40 into account and is calculated such that it increases with increasing high-pressure compressor rotational speed N2, while also increasing with increasing first-order differential value N2dot. Specifically, when the compression force of the high-pressure compressor 24 is large, the rotational-speed-based fuel flow rate N2_mod is calculated to be a large value and in contrast, when the compression force is small, the flow rate N2_mod is calculated to be a small value.

A pressure correction calculating block 82b4 of the second block 82b is inputted with the inflowing air pressure P1 and based thereon, a pressure correction coefficient β is calculated. The pressure correction coefficient β is obtained by dividing the pressure P1 by the standard atmospheric pressure (1.0332 kgf/cm²).

The calculated temperature-based fuel flow rate Wf_st, rotational-speed-based fuel flow rate N2_mod and pressure correction coefficient β are multiplied at a multiplication block 82b5 to obtain a second engine-start fuel flow rate Wf_St. In other words, the second engine-start fuel flow rate Wf_St is corrected by the fuel correction coefficient β.

The calculated first engine-start fuel flow rate Wf_P3 and second engine-start fuel flow rate Wf_St are inputted to the switching block 82c. The exhaust gas temperature EGT is also inputted to the switching clock 82c.

In the switching block 82c, based on the exhaust gas temperature EGT, the processing for switching between the two fuel flow rates is conducted.

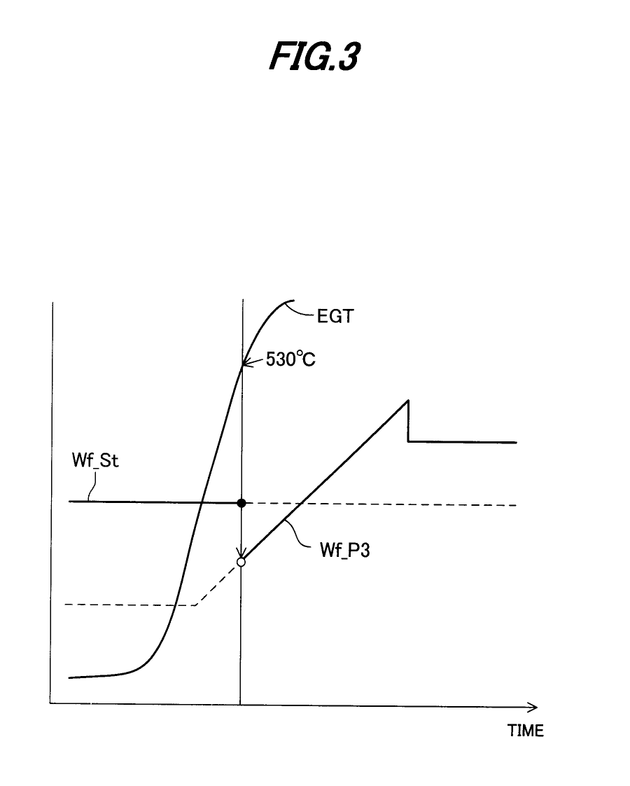

FIG. 3 is a time chart for explaining the processing.

As shown, when the exhaust gas temperature EGT exceeds 530° C., the fuel flow rate at engine starting is switched from the second engine-start fuel flow rate Wf_St to the first engine-start fuel flow rate Wf_P3. In other words, when the exhaust gas temperature EGT is equal to or less than 530° C., the second engine-start fuel flow rate Wf_St is selected as the fuel flow rate at engine starting, while, when the exhaust gas temperature EGT exceeds 530° C., the first engine-start fuel flow rate Wf_P3 is selected.

The switching block 82c outputs a drive command value for the fuel metering valve 32 in accordance with the selected flow rate. Based on the drive command value, the fuel metering valve 32 is opened/closed to supply fuel at the selected flow rate or thereabout to the fuel nozzle 28.

As stated above, the embodiment is configured to have an apparatus (1) for controlling a flow rate of fuel to be supplied to a combustion chamber (26) of a gas turbine engine (10), a turbine (high-pressure turbine 40 or low-pressure turbine 42) rotated by combustion gas injected from the combustion chamber, and a compressor (high-pressure compressor 24 or low-pressure compressor 16) for compressing air to be supplied to the combustion chamber, comprising: a first pressure sensor (P3 sensor 74) that detects output pressure of the compressor (P3); a first temperature sensor (T1 sensor 68) that detects temperature of inflowing air (T1) at an air intake (66) of the engine; a second temperature sensor (EGT sensor 76) that detects temperature of exhaust gas (EGT) passed through the turbine; a rotational speed sensor (N2 sensor 64 or N1 sensor 62) that detects rotational speed of the compressor (N2 or N1); a first engine-start fuel flow rate calculator (ECU 82, first engine-start fuel flow rate calculating block 82a) that calculates a first fuel flow rate at starting of the engine (Wf_P3) based on at least the detected output pressure of the compressor (P3); a second engine-start fuel flow rate calculator (ECU 82, second engine-start fuel flow rate calculating block 82b) that calculates a second fuel flow rate at starting of the engine (Wf_St based on at least the detected temperature of the inflowing air (T1), the exhaust gas temperature (EGT) and the rotational speed of the compressor (N2 or N1, specifically N2); a fuel metering valve (32) that is installed in a fuel supply line (38) of the engine to regulate the flow rate of the fuel to be supplied to the combustion chamber; and a fuel metering valve controller (ECU 82, engine-start fuel flow rate switching block 82c) that selects one of the first fuel flow rate and the second fuel flow rate based on the detected exhaust gas temperature and controls operation of the fuel metering valve based on the selected fuel flow rate. Specifically, the fuel metering valve controller selects the first fuel flow rate when the exhaust gas temperature (EGT) exceeds a predetermined value (530° C.).

With this, since not only the first engine-start fuel flow rate Wf_P3 calculated based on the output pressure P3 of the compressor (high-pressure compressor 24) is always applied as the fuel flow rate at engine starting, but also the second engine-start fuel flow rate Wf_St calculated based on a variety of parameters such as the inflowing temperature T1, exhaust gas temperature EGT, compressor rotational speed N1 and inflowing air pressure P1 is also applied, even when the engine 10 is in the unstable range where the exhaust gas temperature EGT is low, it becomes possible to achieve the optimal fuel flow rate at engine starting, thereby enabling to prevent white smoke, which tends to be generated with the degradation in spray performance at engine starting.

In the apparatus and method, the first engine-start fuel flow rate calculator calculates the first fuel flow rate (Wf_P3) based on the detected output pressure of the compressor (P3) and the temperature of the inflowing air (T1).

In the apparatus and method, the first engine-start fuel flow rate calculator calculates the first fuel flow rate (Wf_P3) such that a ratio of the first fuel flow rate to the detected output pressure of the compressor is a constant value.

In the apparatus and method, the first engine-start fuel flow rate calculator calculates a correction coefficient (α) based on the detected temperature of the inflowing air (T1) and corrects the first fuel flow rate by the correction coefficient (α).

In the apparatus and method, the second engine-start fuel flow rate calculator calculates a temperature-based fuel flow rate (Wf_st) based on the detected temperature of the inflowing air (T1) and the exhaust gas temperature (EGT), calculates a rotational-speed-based fuel flow rate (N2_mod) based on the detected rotational speed of the compressor (N2) and calculates the second fuel flow rate (Wf_St) based on at least the calculated temperature-based fuel flow rate and the rotational-speed-based fuel flow rate.

The apparatus and method further includes: a second pressure sensor (P1 sensor) that detects pressure of the inflowing air (P1); and the second engine-start fuel flow rate calculator calculates a correction coefficient (β) based on the detected pressure of the inflowing air (P1) and corrects the second fuel flow rate by the correction coefficient (β).

In the apparatus and method, the second engine-start fuel flow rate calculator calculates the temperature-based fuel flow rate (Wf_st) based on the detected temperature of the inflowing air (T1) and the exhaust gas temperature (EGT) such that the temperature-based fuel flow rate decreases with increasing inflowing air temperature and increases with increasing exhaust gas temperature.

In the apparatus and method, second engine-start fuel flow rate calculator calculates the rotational-speed-based fuel flow rate (N2_mod) based on the detected rotational speed of the compressor (N2) such that the rotational-speed-based increases with increasing rotational speed of the compressor and increases with increasing change rate of the rotational speed of the compressor.

With this, it becomes possible to calculate more appropriate fuel flow rate at engine starting as the first or second engine-start fuel flow rate.

It should be noted that, although the two-shaft turbofan engine is taken as an example in the foregoing, the apparatus according to this invention can be applied to the turbojet engine, another type of turbofan engine, the turboprop engine and the turboshaft engine.

Japanese Patent Application No. 2009-192934 filed on Aug. 24, 2009, is incorporated by reference herein in its entirety.

While the invention has thus been shown and described with reference to specific embodiments, it should be noted that the invention is in no way limited to the details of the described arrangements; changes and modifications may be made without departing from the scope of the appended claims.

What is claimed is:

1. An apparatus for controlling a flow rate of fuel to be supplied to a combustion chamber of a gas turbine engine having a turbine rotated by combustion gas injected from the combustion chamber and a compressor for compressing air to be supplied to the combustion chamber, comprising:
a first pressure sensor that detects output pressure of the compressor;
a first temperature sensor that detects temperature of inflowing air at an air intake of the engine;
a second temperature sensor that detects temperature of exhaust gas passed through the turbine;
a rotational speed sensor that detects rotational speed of the compressor;
a first engine-start fuel flow rate calculator that calculates a first fuel flow rate at starting of the engine based on at least the detected output pressure of the compressor;
a second engine-start fuel flow rate calculator that calculates a second fuel flow rate at starting of the engine based on at least the detected temperature of the inflowing air, the exhaust gas temperature and the rotational speed of the compressor;
a fuel metering valve that is installed in a fuel supply line of the engine to regulate the flow rate of the fuel to be supplied to the combustion chamber; and
a fuel metering valve controller that selects one of the first fuel flow rate and the second fuel flow rate based on the detected exhaust gas temperature and controls operation of the fuel metering valve based on the selected fuel flow rate.

2. The apparatus according to claim 1, wherein the fuel metering valve controller selects the first fuel flow rate when the exhaust gas temperature exceeds a predetermined value.

3. The apparatus according to claim 1, wherein the first engine-start fuel flow rate calculator calculates the first fuel flow rate based on the detected output pressure of the compressor and the temperature of the inflowing air.

4. The apparatus according to claim 1, wherein the first engine-start fuel flow rate calculator calculates the first fuel flow rate such that a ratio of the first fuel flow rate to the detected output pressure of the compressor is a constant value.

5. The apparatus according to claim 4, wherein the first engine-start fuel flow rate calculator calculates a correction coefficient based on the detected temperature of the inflowing air and corrects the first fuel flow rate by the correction coefficient.

6. The apparatus according to claim 1, wherein the second engine-start fuel flow rate calculator calculates a temperature-based fuel flow rate based on the detected temperature of the inflowing air and the exhaust gas temperature, calculates a rotational-speed-based fuel flow rate based on the detected rotational speed of the compressor and calculates the second fuel flow rate based on at least the calculated temperature-based fuel flow rate and the rotational-speed-based fuel flow rate.

7. The apparatus according to claim 6, further including:
a second pressure sensor that detects pressure of the inflowing air;
and the second engine-start fuel flow rate calculator calculates a correction coefficient based on the detected pressure of the inflowing air and corrects the second fuel flow rate by the correction coefficient.

8. The apparatus according to claim 6, wherein the second engine-start fuel flow rate calculator calculates the temperature-based fuel flow rate based on the detected temperature of the inflowing air and the exhaust gas temperature such that the temperature-based fuel flow rate decreases with increasing inflowing air temperature and increases with increasing exhaust gas temperature.

9. The apparatus according to claim 6, wherein the second engine-start fuel flow rate calculator calculates the rotational-speed-based fuel flow rate based on the detected rotational speed of the compressor such that the rotational-speed-based fuel flow rate increases with increasing rotational speed of the compressor and increases with increasing change rate of the rotational speed of the compressor.

10. A method of controlling a flow rate of fuel to be supplied to a combustion chamber of a gas turbine engine having a turbine rotated by combustion gas injected from the combustion chamber and a compressor for compressing air to be supplied to the combustion chamber, comprising the steps of:
detecting output pressure of the compressor;
detecting temperature of inflowing air at an air intake of the engine;
detecting temperature of exhaust gas passed through the turbine;
detecting rotational speed of the compressor;
calculating a first fuel flow rate at starting of the engine based on at least the detected output pressure of the compressor;
calculating a second fuel flow rate at starting of the engine based on at least the detected temperature of the inflowing air, the exhaust gas temperature and the rotational speed of the compressor; and
selecting one of the first fuel flow rate and the second fuel flow rate based on the detected exhaust gas temperature and controlling operation of a fuel metering valve installed in a fuel supply line of the engine to regulate the flow rate of the fuel to be supplied to the combustion chamber.

11. The method according to claim 10, wherein the step of selecting selects the first fuel flow rate when the exhaust gas temperature exceeds a predetermined value.

12. The method according to claim 10, wherein the step of first engine-start fuel flow rate calculating calculates the first fuel flow rate based on the detected output pressure of the compressor and the temperature of the inflowing air.

13. The method according to claim 10, wherein the step of first engine-start fuel flow rate calculating calculates the first fuel flow rate such that a ratio of the first fuel flow rate to the detected output pressure of the compressor is a constant value.

14. The method according to claim 13, wherein the step of first engine-start fuel flow rate calculating calculates a correction coefficient based on the detected temperature of the inflowing air and corrects the first fuel flow rate by the correction coefficient.

15. The method according to claim 10, wherein the step of second engine-start fuel flow rate calculating calculates a temperature-based fuel flow rate based on the detected temperature of the inflowing air and the exhaust gas temperature, calculates a rotational-speed-based fuel flow rate based on the detected rotational speed of the compressor and calculates the second fuel flow rate based on at least the calculated temperature-based fuel flow rate and the rotational-speed-based fuel flow rate.

16. The method according to claim 15, further including the step of:
detecting pressure of the inflowing air;
and the step of second engine-start fuel flow rate calculating calculates a correction coefficient based on the detected pressure of the inflowing air and corrects the second fuel flow rate by the correction coefficient.

17. The method according to claim 15, wherein the step of second engine-start fuel flow rate calculating calculates the temperature-based fuel flow rate based on the detected temperature of the inflowing air and the exhaust gas temperature such that the temperature-based fuel flow rate decreases with increasing inflowing air temperature and increases with increasing exhaust gas temperature.

18. The method according to claim 15, wherein the step of second engine-start fuel flow rate calculating calculates the rotational-speed-based fuel flow rate based on the detected rotational speed of the compressor such that the rotational-speed-based fuel flow rate increases with increasing rotational speed of the compressor and increases with increasing change rate of the rotational speed of the compressor.
